(19) United States
(12) Patent Application Publication
(10) Pub. No.: US 2026/0283895 A1
(43) Pub. Date: Sep. 24, 2026

(54) MASSAGE ASSEMBLY AND MASSAGE DEVICE

(71) Applicant: Reestar International Limited, Hong Kong (CN)

(72) Inventors: Xili Wu, Hong Kong (CN); Baoyan Wei, Hong Kong (CN); Gaoming Liang, Hong Kong (CN)

(21) Appl. No.: 19/221,565

(22) Filed: May 29, 2025

(30) Foreign Application Priority Data
Mar. 21, 2025 (CN) 202520511656.3

(51) Int. Cl. A61H 9/00

(52) U.S. Cl. CPC A61H 9/0078; A61H 2201/1215; A61H 2201/14; A61H 2201/1418; A61H 2201/164; A61H 2201/1654; A61H 2201/1669; A61H 2201/1695; A61H 2205/12

(57) ABSTRACT

A massage assembly includes a first massage member, a second massage member, a driving motor, and a gear assembly. The gear assembly includes a first gear, a second gear, a third gear, a first rotating shaft, and a second rotating shaft, the first gear is connected with a working end of the driving motor, and both the first gear and the second gear are sleeved on the first rotating shaft; the third gear is engaged with the second gear, and the third gear is sleeved on the second rotating shaft, the second rotating shaft is configured to drive the first massage member and the second massage member to rotate, the number of gear teeth of the third gear is greater than that of the second gear.

### CROSS REFERENCE TO RELATED APPLICATIONS

The present application claims the priority of Chinese patent application No. 202520511656.3, filed on March 21, 2025, contents of which are incorporated herein by its entireties.

The present disclosure relates to the field of massage equipment, and particularly to a massage assembly and a massage device.

### BACKGROUND

The massage device in the art is generally provided with a massage assembly. The massage assembly can effectively massage the target areas of a user, such as the soles of the feet and the back, facilitating blood circulation, alleviating fatigue, and helping users relax and exercise. The massage assembly typically includes at least a first massage member and a second massage member, which are driven by a driving motor to perform the massage. Since the driving motor needs to simultaneously drive both the first massage member and the second massage member, the load is substantial, causing the driving motor being prone to overloading and damage. Therefore, improving the load capacity of the driving motor is a critical issue that the massage assembly needs to address.

### SUMMARY

In order to overcome at least some of the deficiencies and drawbacks in the related art, the present disclosure provides a massage assembly and a massage device to enhance the load capacity of the driving motor, the damage of the driving motor due to overload is prevented, such that the service life of the massage assembly and massage device can be extended.

On the one hand, the present disclosure provides a massage assembly. The massage assembly includes a first massage member, a second massage member, a driving motor, and a gear assembly. The gear assembly includes a first gear, a second gear, a third gear, a first rotating shaft, and a second rotating shaft, the first gear is connected with a working end of the driving motor, and both the first gear and the second gear are sleeved on the first rotating shaft; the third gear is engaged with the second gear, and the third gear is sleeved on the second rotating shaft, the second rotating shaft is configured to drive the first massage member and the second massage member to rotate, the number of gear teeth of the third gear is greater than that of the second gear.

On the other hand, the present disclosure provides a massage device, the massage device includes a housing and the massage assembly mentioned above, the housing is provided with an entrance and a receiving space, the entrance communicates with the receiving space, the massage assembly is arranged within the receiving space.

According to the above, the massage assembly provided by the present disclosure can enhance the load capacity of the driving motor by the arrangement of a driving motor and a gear assembly as depicted below. The gear assembly includes a first gear, a second gear, a third gear, a first rotating shaft, and a second rotating shaft. The first gear and the second gear are sleeved on the first rotating shaft to achieve a coaxial rotation. The driving motor connected to the first gear, the third gear engages with the second gear, the number of gear teeth of the third gear is greater than that of the second gear, in this way, the rotating speed of the third gear is reduced and the torque of the third gear is increased. Therefore, via the third gear, the driving motor is capable of simultaneously driving both the first massage member and the second massage member to rotate. As a result, the load capacity of the driving motor is improved, motor overload and damage is prevented, and the service life of the massage assembly and the massage device is extended.

### BRIEF DESCRIPTION OF THE DRAWINGS

To provide a clearer illustration of the technical solutions in the embodiments of the present disclosure or in the related art, a brief introduction will be given to the drawings used in the description of the embodiments or the related art. It is obvious that the drawings described below are merely some embodiments of the present disclosure, and for those skilled in the art, other drawings can be obtained based on these drawings without creative efforts.

FIG. 1 is a structural schematic view of a massage assembly according to an embodiment of the present disclosure.

FIG. 2 is a structural schematic view of the massage assembly shown in FIG. 1 from another angle.

FIG. 3 is an exploded view of the massage assembly shown in FIG. 1.

FIG. 4A is a structural schematic view of the gear assembly shown in FIG. 3.

FIG. 4B is a structural schematic view of the gear assembly shown in FIG. 4A from another angle.

FIG. 5 is a cross-sectional view taken along the line A-A' shown in FIG. 1.

FIG. 6 is a structural schematic view of the base plate shown in FIG. 3.

FIG. 7 is a structural schematic view of the first massage member shown in FIG. 3.

FIG. 8 is a structural schematic view of the first massage member shown in FIG. 7 from another angle.

FIG. 9 is a structural schematic view of the second massage member shown in FIG. 3.

FIG. 10 is a structural schematic view of the second massage member shown in FIG. 9 from another angle.

FIG. 11 is an exploded view of the second massage member and the fastener shown in FIG. 3.

FIG. 12 is a structural schematic view of the fastener shown in FIG. 11.

FIG. 13 is a structural schematic view of another massage assembly according to an embodiment of the present disclosure.

FIG. 14 is a structural schematic view of the supporting portion shown in FIG. 13.

FIG. 15 is a structural schematic view of the third massage member shown in FIG. 13.

FIG. 16 is a structural schematic view of the electrical connection structure of the driving motor and the driving module in the massage assembly according to an embodiment of the present disclosure.

FIG. 17 is a structural schematic view of a massage device according to an embodiment of the present disclosure.

FIG. 18 is an exploded view of the massage device shown in FIG. 17.

FIG. 19 is a structural schematic view of the lower housing shown in FIG. 17.

### DETAILED DESCRIPTION

To further clarify the objectives, technical solutions, and advantages of the embodiments of the present application, detailed descriptions of the embodiments are provided below with reference to the accompanying drawings. It should be understood that the described embodiments represent only a portion of the embodiments of the present application and that the scope of the present application is not limited thereto. Any other embodiments that can be derived by those skilled in the art based on the described embodiments, without creative efforts, shall fall within the scope of the present application.

It should be noted that all directional indications in the embodiments of the present application (such as up, down, left, right, front, rear, top, bottom) are used only to explain the relative positional relationships, movement conditions, etc., between components in a specific posture (as shown in the drawings). If the specific posture changes, the directional indications will accordingly change. In addition, the term "vertical" used in the embodiments and claims of the present application refers to an angle of 90° between two components or a deviation of -5° to +5°; the term "parallel" refers to an angle of 0° between two components or a deviation of -5° to +5°; and the term "flush" refers to a height difference between two components being 0 or a deviation of 0 to 2 cm.

In the embodiments of the present application, terms such as "first," "second," and so on are used for descriptive purposes only and should not be construed as indicating or implying their relative importance or implicitly specifying the number of the technical features referred to. Thus, features designated as "first," "second," etc. may explicitly or implicitly include at least one of the respective features.

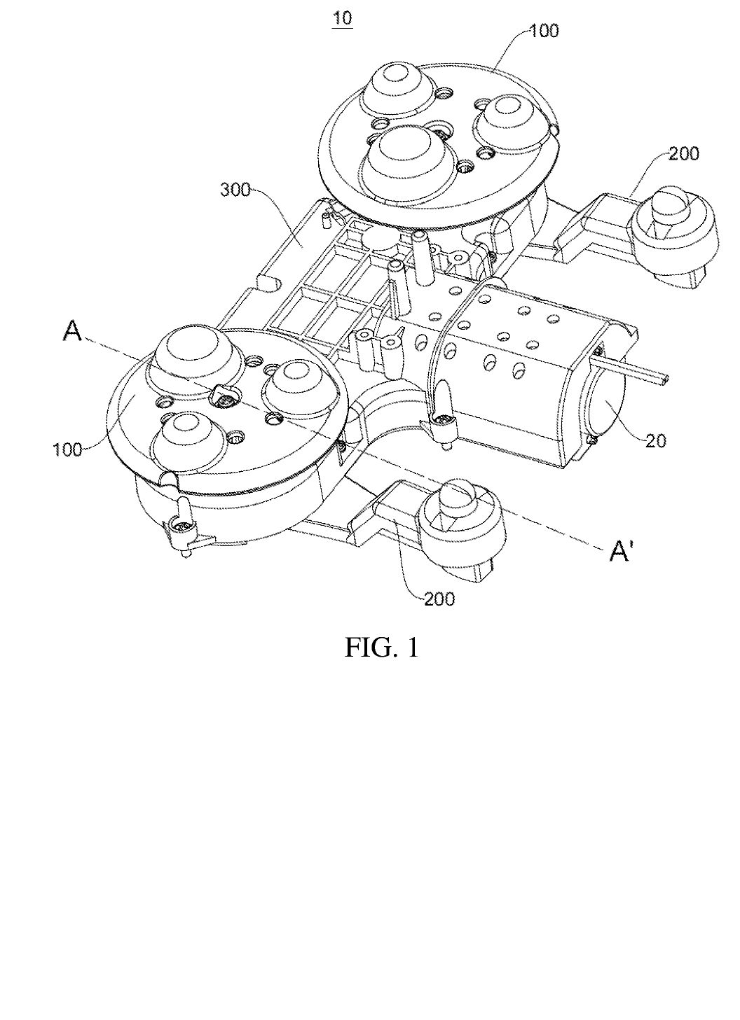

As shown in FIGS. 1 to FIG. 4B, the present disclosure provides a massage assembly 10. The massage assembly 10 is configured to massage target areas of a user such as the foot, the back, and a substantially planar surface including multiple areas. The massage assembly includes a first massage member 100, a second massage member 200, a driving motor 20 and a gear assembly 30.

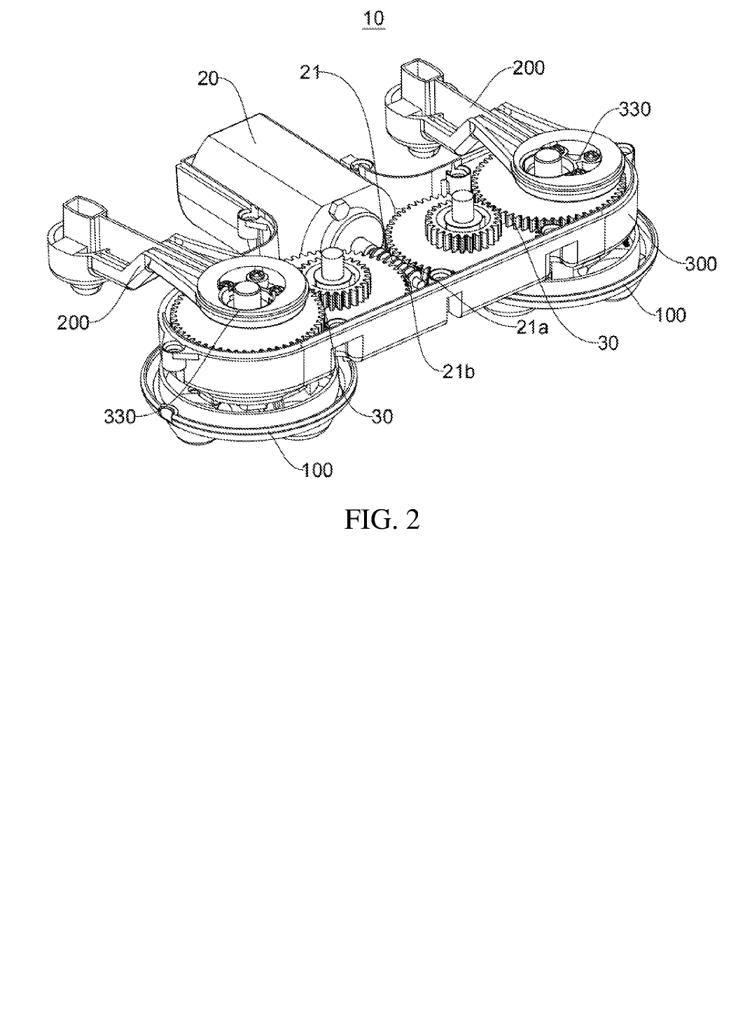

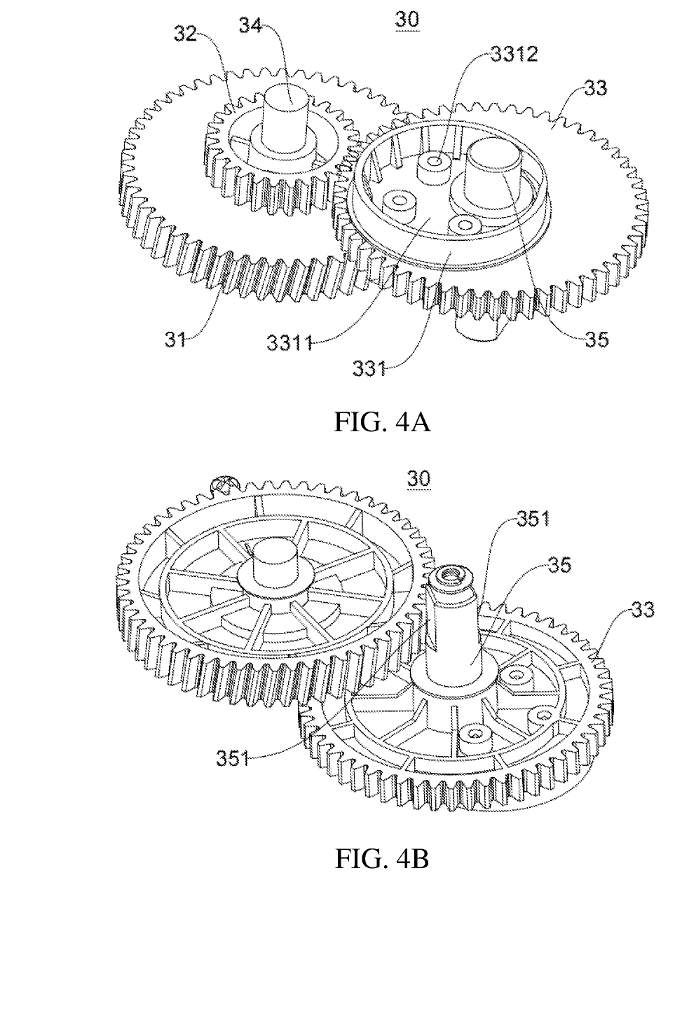

The first massage member 100 is configured to massage a first target area of the user, while the second massage member 200 is configured to massage a second target area of the user. As shown in FIGS. 2 and FIG. 4A, the gear assembly 30 may include a first gear 31, a second gear 32, a third gear 33, a first rotating shaft 34, and a second rotating shaft 35. A working end 21 of the driving motor 20 is engaged with the first gear 31 to drive the first gear 31 to rotate. Both the first gear 31 and the second gear 32 are sleeved on the first rotating shaft 34, such that the first gear 31 can drive the first rotating shaft 34 to rotate, and the first rotating shaft 34 can drive the second gear 32 to rotate, in this way, the first gear 31 and the second gear 32 can rotate coaxially. The second gear 32 is engaged with the third gear 33 to drive the third gear 33 to rotate. The third gear 33 is sleeved on the second rotating shaft 35, the third gear 33 connects the first massage member 100 and the second massage member 200 with each other through the second rotating shaft 35, such that the driving motor 20 can simultaneously drive both the first massage member 100 and the second massage member 200. Since the first gear 31 and the second gear 32 are able to rotate coaxially, and the third gear 33 is configured to has a greater number of gear teeth than the second gear 32, a rotating speed of the third gear 33 is reduced, and a torque of the third gear 33 is increased. Therefore, a load capacity of the driving motor 20 is enhanced, and motor overload and damage caused by simultaneous driving of the first massage member 100 and the second massage member 200 are prevented. In an embodiment, the massage assembly 10 is applied to massage feet, in this embodiment, the first target massage area is a center of a foot, and the first massage member 100 is configured to massage the center of the foot; the second target massage area is a heel of the foot, and the second massage member 200 is configured to massage the heel of the foot.

In an embodiment, the number of gear teeth of the first gear 31 is greater than that of the second gear 32, in this way, the rotating speed can be further reduced, the torque can be further increased, and the load capacity of the driving motor 20 can be further enhanced.

In an embodiment of the present disclosure, the working end of the driving motor is configured as a worm, the first gear 31 is configured as a worm wheel, and the worm engages with the worm wheel, therefore the driving motor 20 is able to drive the first gear 31 to rotate. The worm includes a rod-shaped component, an outer surface of the rod-shaped component is formed as a helical structure, and a plurality of helical gear teeth surrounding the rod-shaped component forms the helical structure. The plurality of helical gear teeth of the worm and a plurality of gear teeth of the worm wheel are conjugate with each other, enabling a precise engagement. When the worm rotates, the first gear 31 rotates with the rotation of the worm, such that motion transfer is achieved. It should be understood that the number of the plurality of helical gear teeth on the worm is less than the number of the gear teeth on the first gear 31. The engagement between the worm and the first gear 31 provides a large transmission ratio, which helps reduce speed and increase the torque of the driving motor 20, ultimately enhancing the load capacity of the driving motor 20.

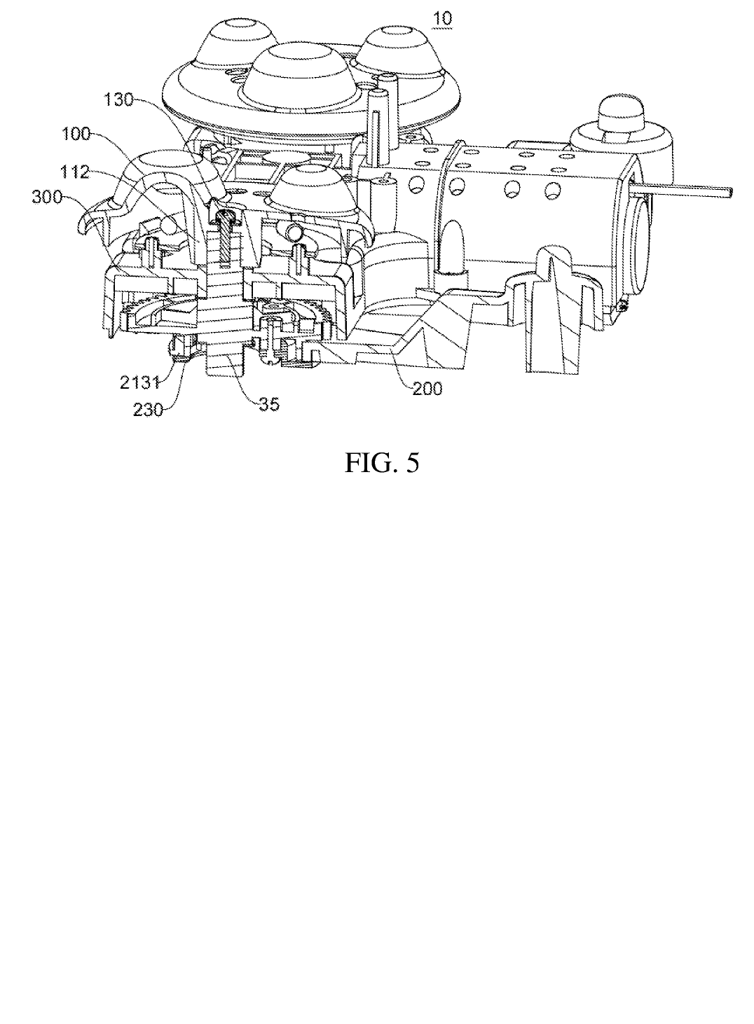

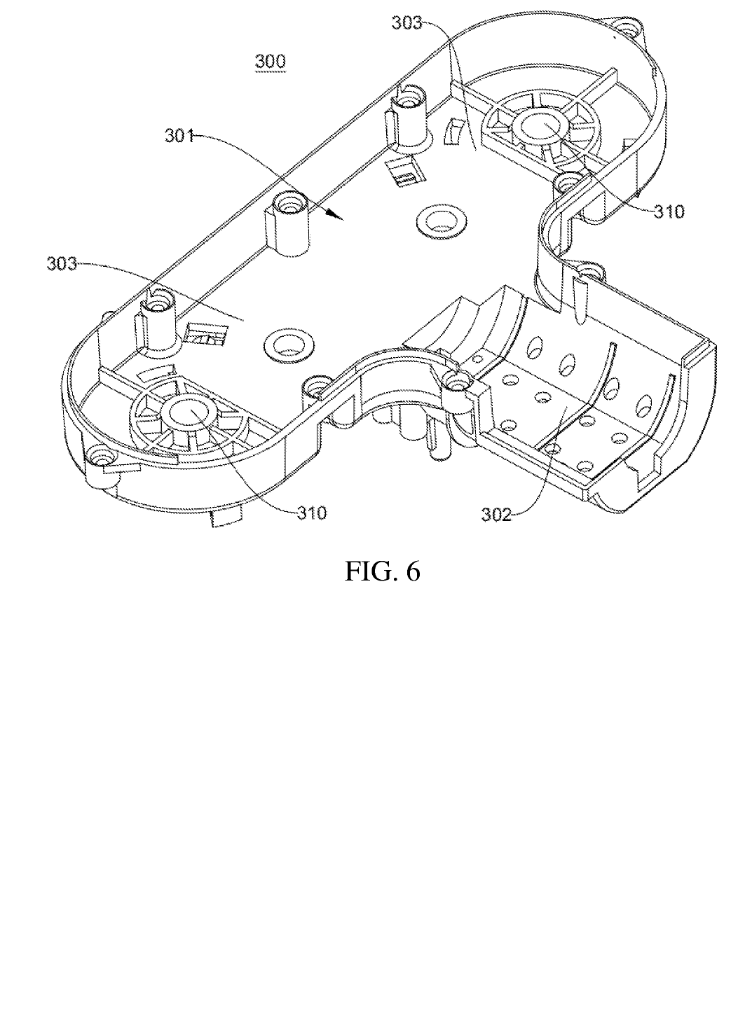

Referring to FIG. 2, FIGS. 5 and FIG. 6, the massage assembly 10 provided by the present disclosure further includes a base plate 300, a cavity 301 is defined in the base plate 300, the driving motor 20 and the gear assembly 30 are arranged within the cavity 301. In this way, the driving motor 20 and the gear assembly 30 can be fixedly installed, and the motion stability is improved.

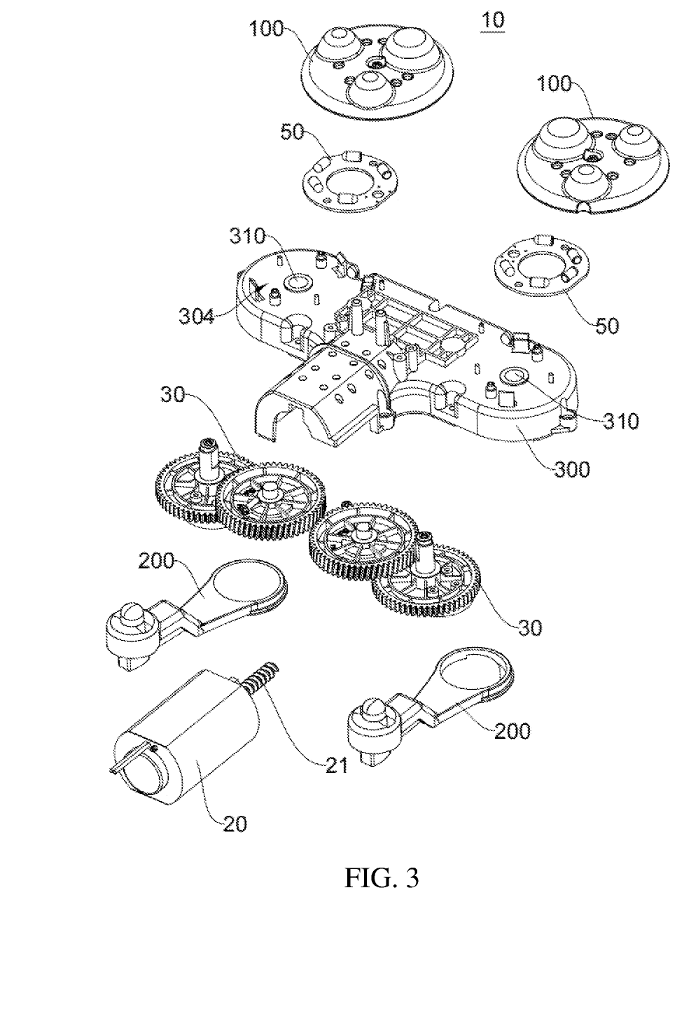

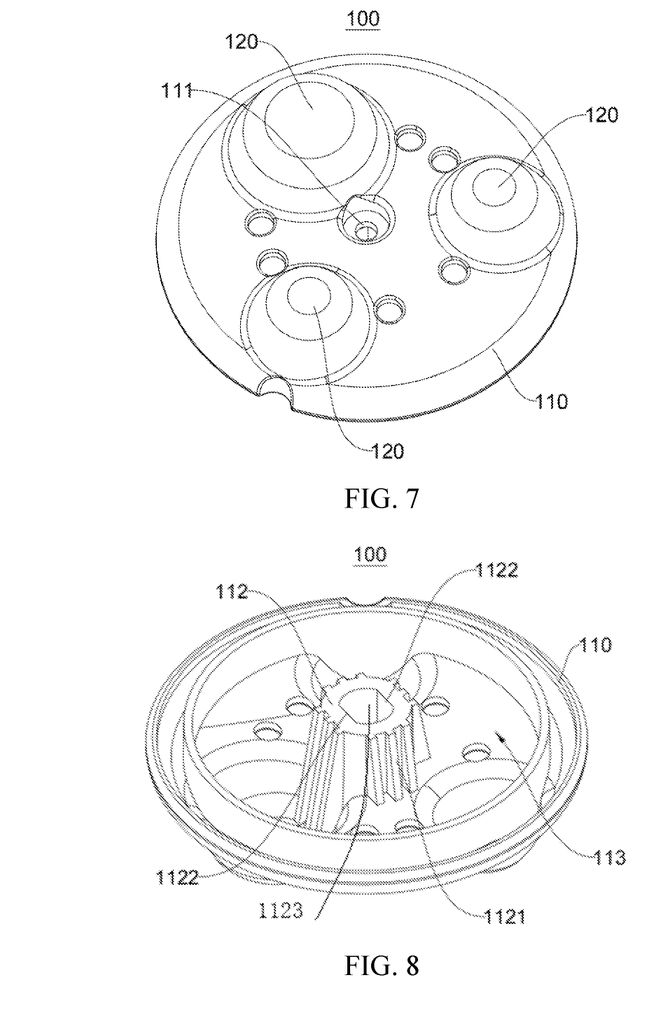

Referring to FIG. 7, the first massage member 100 includes a tray 110 and at least one first massage head 120, and the at least one first massage head 120 is disposed on the tray 110. The tray 110 can be configured as a circular or substantially circular structure, a shape of the substantially circular structure is similar to a circle, such as a disc or oval structure. The first massage head 120 can be configured as a hemispherical protrusion, which provides a smooth contact surface when in contact with the user, therefore the user can feel more comfortable during the massage. In an embodiment of the present disclosure, the first massage member 100 includes only one first massage head 120, and the first massage head 120 is positioned at the center of the tray 110. In another embodiment of the present disclosure, the first massage member 100 includes a plurality of first massage heads 120, and the plurality of the first massage heads 120 are distributed around the tray 110. For example, three first massage heads 120 may be provided in an embodiment, the three first massage heads 120 are evenly spaced around the tray 110. In this embodiment, the three first massage heads 120 may have a same size and a same shape, or one of the three first massage heads 120 may be larger than the other two of the three first massage heads 120. It should be understood that, this embodiment is not limited thereto. As shown in FIG. 1, FIG. 3, FIGS. 6 and FIG. 7, a connecting through-hole 310 is defined in the base plate 300, and the tray 110 is disposed on an upper side 304 of the base plate 300 (i.e., a side opposite the cavity 301), the second rotating shaft 35 passes through the connecting through-hole 310 to connect to the tray 110. When the second rotating shaft 35 rotates, the second rotating shaft 35 drives the tray 110 to rotate, and the first massage head 120 on the tray 110 moves simultaneously, in this way, the first target massage area of the user can be massaged through the motion of the first massage head 120. In this embodiment, a gap may be positioned between the tray 110 and the base plate 300, that is, the tray 110 does not contact the base plate 300, preventing vibrations generated when the driving motor 20 drives the gear assembly 30 to move from being transmitted to the tray 110, such that the controllability and stability of the tray 110 are enhanced, and the user experience is improved.

Referring to FIGS. 7 and FIG. 8, a connecting sleeve 112 is further disposed on the tray 110. The connecting sleeve 112 is located at the bottom 113 of the tray 110, that is, the connecting sleeve 112 is on a side of the tray 110 away from the first massage head 120. The connecting sleeve 112 may have a hollow structure, that is, a connecting hole 1123 is defined inside the connecting sleeve 112, and a first limiting plane 1122 is provided on an inner wall of the connecting sleeve 112. As shown in FIG. 4B, FIGS. 5, and FIG. 6, a second limiting plane 351 may be provided on the second rotating shaft 35. A portion of the second rotating shaft 35, extending out of the connecting through-hole 310, extends into the connecting hole 1123 of the connecting sleeve 112. The first limiting plane 1122 and the second limiting plane 351 are oppositely arranged, and both of the first limiting plane 1122 and the second limiting plane 351 are configured as planar surfaces. The size and structure of the connecting hole 1123 may be adapted with the size and structure of the second rotating shaft 35, such that the second rotating shaft 35 can be tightly connected within the connecting sleeve 112. The first limiting plane 1122 abuts against the second limiting plane 351 to provide a circumferential limitation. In this way, the second rotating shaft 35 can be prevented from rotating within the connecting sleeve 112, and the stability of the connection between the second rotating shaft 35 and the connecting sleeve 112 is improved.

In an embodiment, as shown in FIGS. 5 and FIG. 7, the first massage member 100 further includes a first locking member 130, and a first locking hole 111 is defined in the tray 110, the first locking hole 111 communicates with the connecting hole 1123 of the connecting sleeve 112, and the first locking member 130 passes through the first locking hole 111 to be further connected to an interior of the second rotating shaft 35. The first locking member 130 may be a fastening screw. In this way, the tray 110 can be further fixedly connected to the second rotating shaft 35, such that the stability of the connection is improved. Furthermore, as shown in FIG. 8, the peripheral side of the connecting sleeve 112 may be arranged with a reinforcing rib 1121 or multiple reinforcing ribs 1121, and each reinforcing rib 1121 is inclined at an angle. In this way, the strength of the connecting sleeve 112 can be improved, and the connection stability can be enhanced.

Referring to FIGS. FIG .9 and 10, the second massage member 200 includes a connecting rod 210 and a second massage head 220. The second massage head 220 may also be a hemispherical protrusion. The connecting rod 210 comprises a first end 211 and a second end 212, the second massage head 220 is disposed on the first end 211, and the second end 212 is eccentrically connected with the third gear 33. In this way, the third gear 33 is able to drive the second massage head 220 to reciprocate along an arcuate trajectory, and the second target massage area of the user can be massaged. In an embodiment of the present disclosure, the connecting rod 210 and the second massage head 220 may be configured as an integral and one-piece structure. It should be understood that the connecting rod 210 and the second massage head 220 may be configured in other manners.

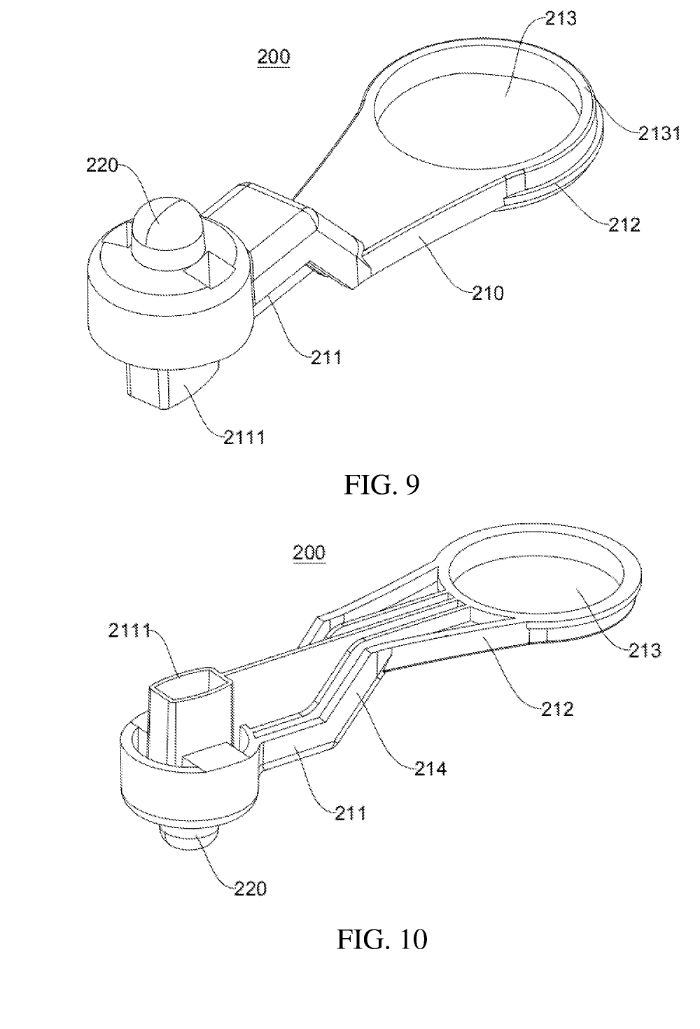

Referring to FIGS. FIG .2 and 4A, a cam structure 330 may be provided on the third gear 33, the cam structure 330 is eccentrically arranged with the second rotating shaft 35, and the cam structure 330 rotates along with the second rotating shaft 35. Referring to FIG. 2, FIGS. 4A, and FIG. 9, an eccentric hole 213 is defined at the second end 212 of the connecting rod 210, the eccentric hole 213 is sleeved on the cam structure 330, such that the connecting rod 210 can be fixedly connected to the cam structure 330 through the eccentric hole 213.

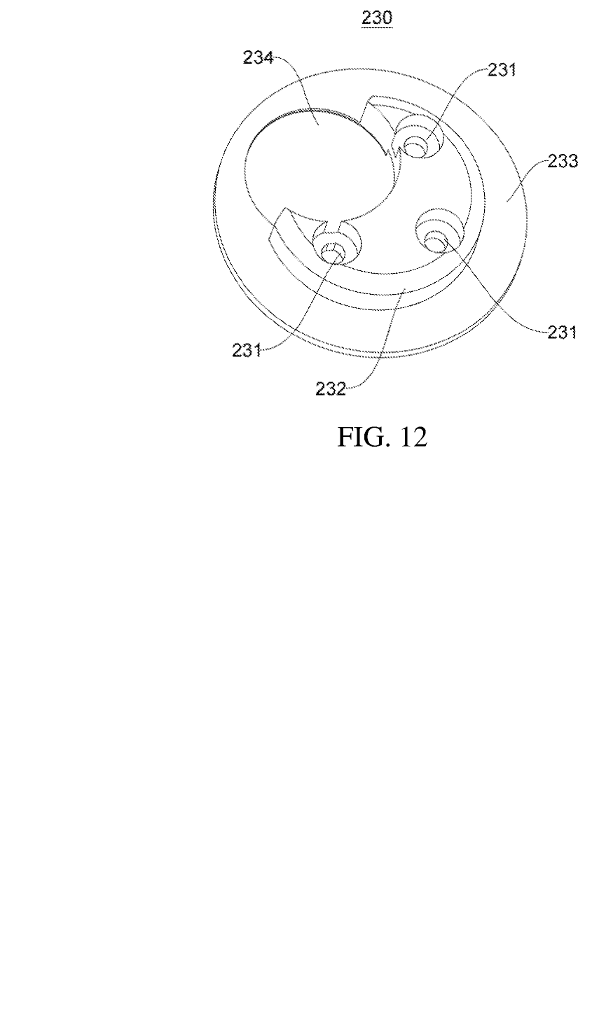

Referring to FIG. 2, FIG. 4A, FIG. 5, FIGS. 11, and FIG. 12, the cam structure 330 includes a cam 331 and a fastener 230, the cam 331 is disposed on the third gear 33 and is eccentrically arranged relative to the second rotating shaft 35, the connecting rod 210 is sleeved on the cam 331 through the eccentric hole 213, and the fastener 230 fixedly connects the connecting rod 210 and the cam 331 with each other. The cam 331 may be a protruding annular structure surrounding the second rotating shaft 35, the second rotating shaft 35 is eccentrically arranged relative to the center of the cam 331. In this embodiment, the eccentric hole 213 and the cam 331 may be interference-fit to prevent the cam 331 from rotating within the eccentric hole 213.

In an embodiment, the cam structure 330 further includes a second locking member 240, the fastener 230 is provided with a second locking hole 231, a connecting protrusion 232, and a first limiting portion 233, and the first limiting portion 233 is arranged around the connecting protrusion 232. A fixing groove 3311 is defined in the cam 331, a fastening connection portion 3312 is arranged within the fixing groove 3311, the fastening connection portion 3312 may be disposed on the third gear 33 and serves as a connecting column, and a fastening hole is defined in the fastening connection portion 3312. The connecting protrusion 232 is arranged within the fixing groove 3311, and the first limiting portion 233 covers the cam 331 and a hole wall 2131 of the eccentric hole 213. The first limiting portion 233 contacts at least one of the cam 331 and the hole walls 2131. The second locking member 240 passes through the second locking hole 231 and is fixedly connected to the fastening connection portion 3312. The second locking member 240 may be a screw, a bolt, or other fastening element, and the second locking hole 231 may be configured as a through hole. An inner wall of the fastening connection portion 3312 may be arranged with threads. It should be expressly noted that the present embodiment is not limited to these specific implementations. An avoidance hole 234 may be defined in the fastener 230 to avoid the second rotating shaft 35, that is, the second rotating shaft 35 can pass through the avoidance hole 234, such that interference between the fastener 230 and the second rotating shaft 35 can be prevented.

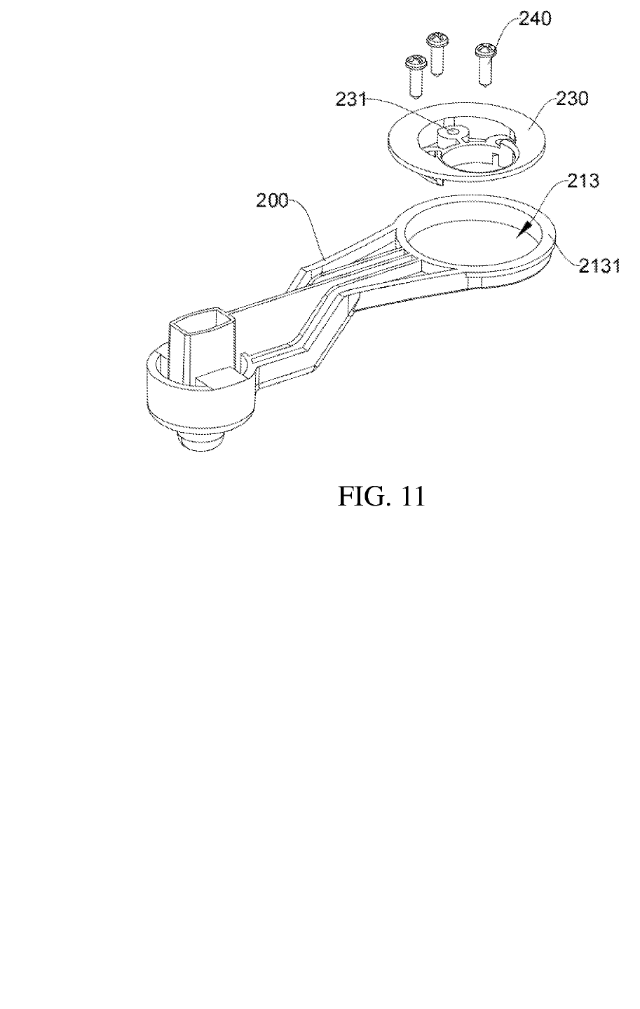

Referring to FIG. 4A, FIG. 5, FIGS. 9 and FIG. 10, the connecting rod 210 is connected to a side of the third gear 33 away from the first massage member 100, for example, the cam 331 is arranged on the side of the third gear 33 opposite to the first massage head 120. The connecting rod 210 may include an intermediate connecting portion 214 positioned between the first end 211 and the second end 212, and the intermediate connecting portion 214 is arranged at an inclined angle. When the second massage head 220 faces upward, the height of the first end 211 is higher than the height of the second end 212, such that the second massage head 220 is flush or substantially flush with the first massage member 100. In this embodiment, being "flush" means that the height difference between the second massage head 220 and the first massage member 100 is 0, or a deviation of 0-2 cm exists between the second massage head 220 and the first massage member 100. Since the intermediate connecting portion 214 is inclined, the first massage member 100 can be sufficiently contacted the first target massage areas of the user, at the same time, the second massage head 220 can be sufficiently contacted to the second target massage areas of the user. Therefore, the contact area of massage is ensured, and the massage effect is improved.

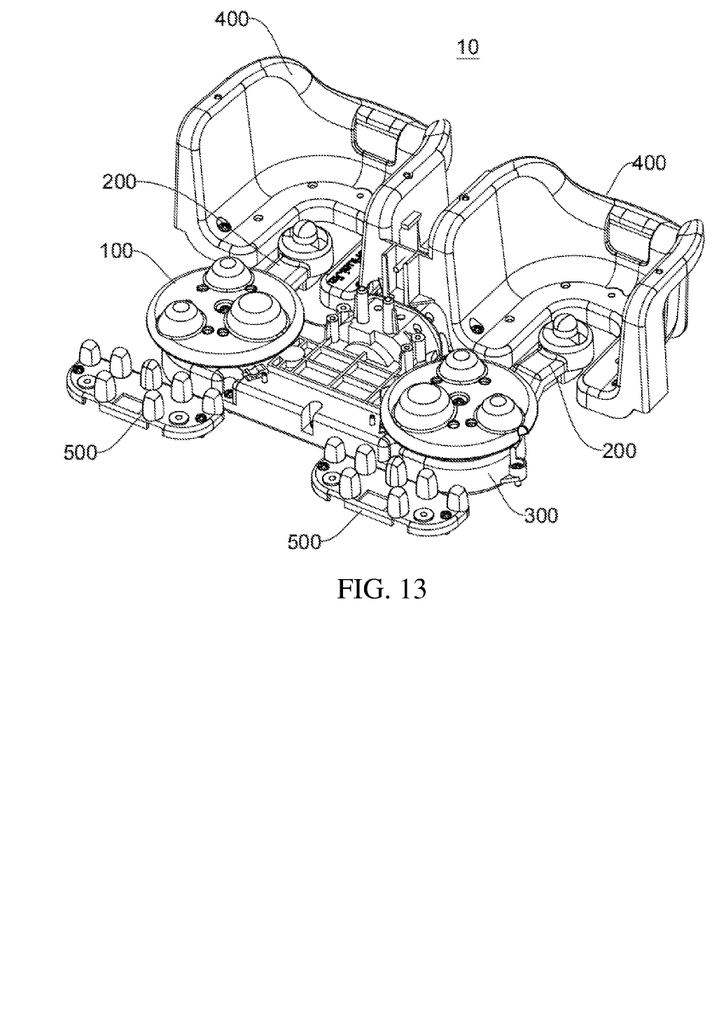

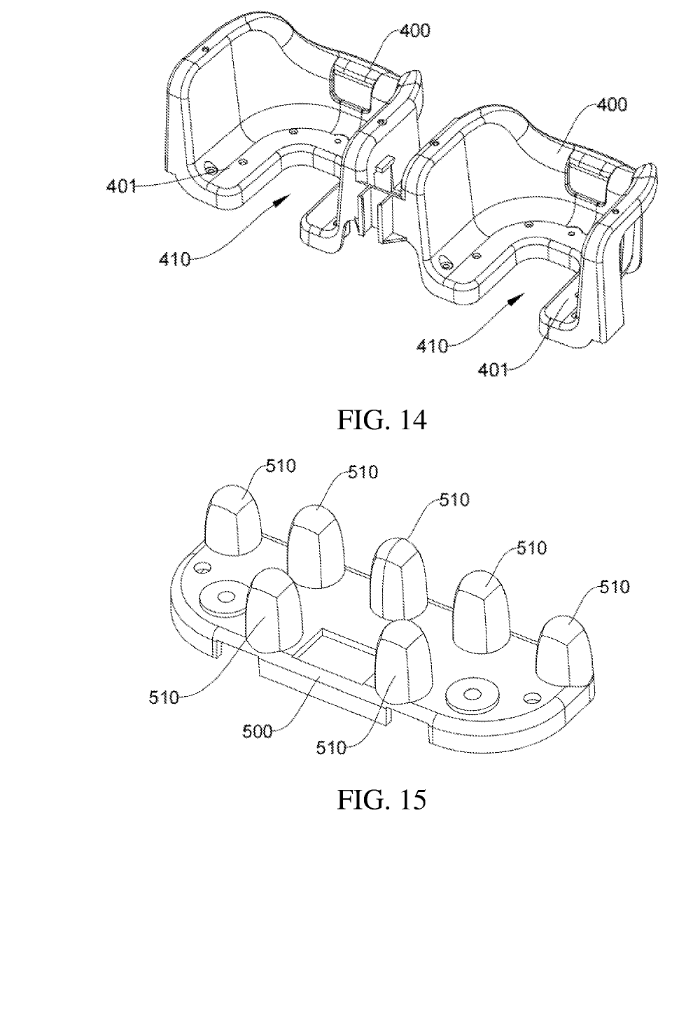

Referring to FIGS. 13 and FIG. 14, the massage assembly 10 further includes a supporting portion 400. When the massage assembly 10 is applied in a foot massage device, the supporting portion 400 is configured to fit the user's heel, and is configured to support the user's foot, allowing the user to comfortably place their foot on the massage assembly 10. A U-shaped groove 410 is defined in the bottom surface 401 of the supporting portion 400, and the second massage head 220 is located within the U-shaped groove 410. The U-shaped groove 410 is configured to limit the movement distance of the second massage head 220. Specifically, when the second massage head 220 moves, the walls of the U-shaped groove 410 can restrict the movement of the second massage head 220, such that the movement distance of the second massage head 220 is limited.

Referring to FIGS. 13 and FIG. 15, the massage assembly 10 further includes a third massage member 500. The third massage member 500 includes a plurality of protrusion elements 510 arranged in an array. When the massage assembly 10 is applied in a foot massage device, the protrusion elements 510 are fixed in a position mated with the position of user's toes. When the user's foot is placed on the massage assembly 10 for massage, an airbag massage assembly 90 presses on the user's foot and heel, enabling the user's foot and heel to move with a pressing action of an airbag. In this embodiment, the toes of user move along with the foot and heel, and when the toes are pressed on the third massage member 500, the third massage member 500 can provide a squeezing massage to the toes. At the same time, the first massage member 100 and the second massage member 200 are driven by the driving motor 20, to massage the center of the foot and the heel. Since the configuration of the first massage member 100, the second massage member 200, and the third massage member 500, the massage effect can be improved.

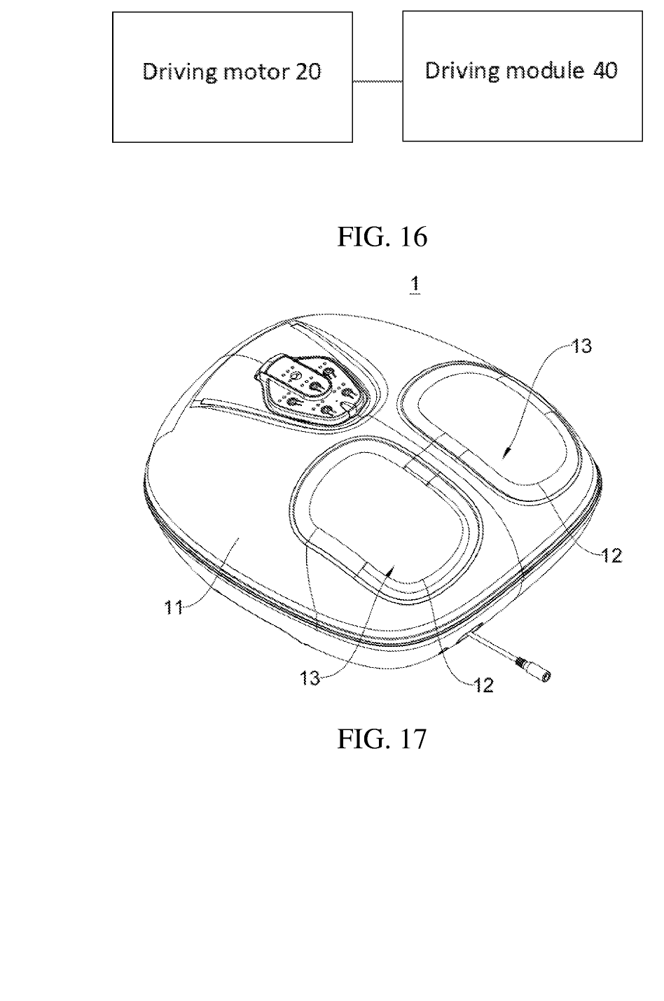

Referring to FIG. 16, in an embodiment, the massage assembly 10 includes a driving module 40, the driving module is electrically connected to the driving motor 20. The driving module 40 is configured to control a rotating speed and a rotating direction of the driving motor 20. By adjusting the rotating speed of the working end 21 of the driving motor 20 according to a corresponding massage level, the user can experience different massage intensities. In addition, the driving module 40 can also control the rotating direction of the working end 21, enabling the working end 21 to rotate in a forward or reverse direction, such that the massage effect is further improved.

In an embodiment, referring to FIG. 2, the massage assembly 10 includes two gear assemblies 30, two first massage members 100, and two second massage members 200. One of the two gear assemblies 30 is arranged on a left side of the working end 21 of the driving motor 20, the other one of the two gear assemblies 30 is arranged on a right side of the working end 21 of the driving motor 20, and the driving motor 20 simultaneously driving both the two gear assemblies 30. Referring to FIGS. 2 and FIG. 6, the cavity 301 may include a motor receiving portion 302 and two gear receiving portions 303. The driving motor 20 is placed within the motor receiving portion 302, and the two gear receiving portions 303 are positioned on two sides (21a and 21b) of the working end 21 of the driving motor 20. The two gear assemblies 30 are respectively arranged within the two gear receiving portions 303, and the two first gears 31 are engaged with the working end 21 of the driving motor 20. In this way, the driving motor 20 can drive two first massage members 100 and two second massage members 200.

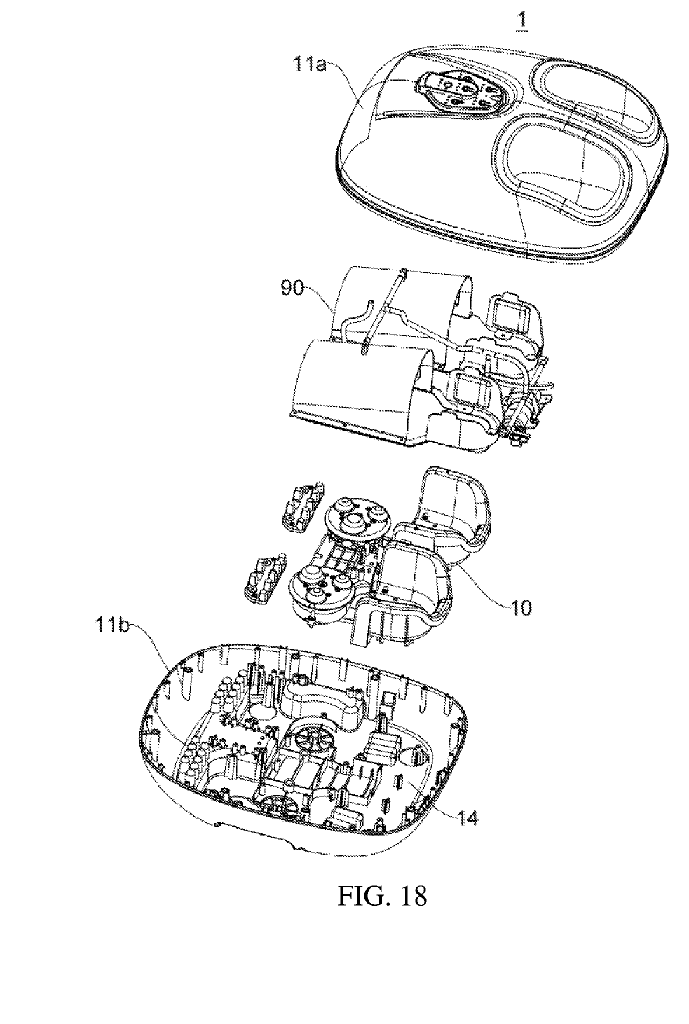

Referring to FIGS. 17 and FIG. 18, the present disclosure also provides a massage device 1. The massage device 1 can be used to massage the user's feet. The massage device 1 includes a housing 11 and the massage assembly 10 as described in any of the above embodiments. The housing 11 may have an entrance 12 and a receiving space 13, the entrance 12 communicates with the receiving space 13, such that the user's feet can enter the receiving space 13 through the entrance 12. The massage assembly 10 is positioned within the receiving space 13 to massage the user's feet in the receiving space 13. In this embodiment, the receiving space 13 may include a partition separating the user's feet from the massage assembly 10, to prevent direct contact between the user's feet and the massage assembly 10. The partition may be made of a fabric bag or cotton bag to enhance the comfort of the massage.

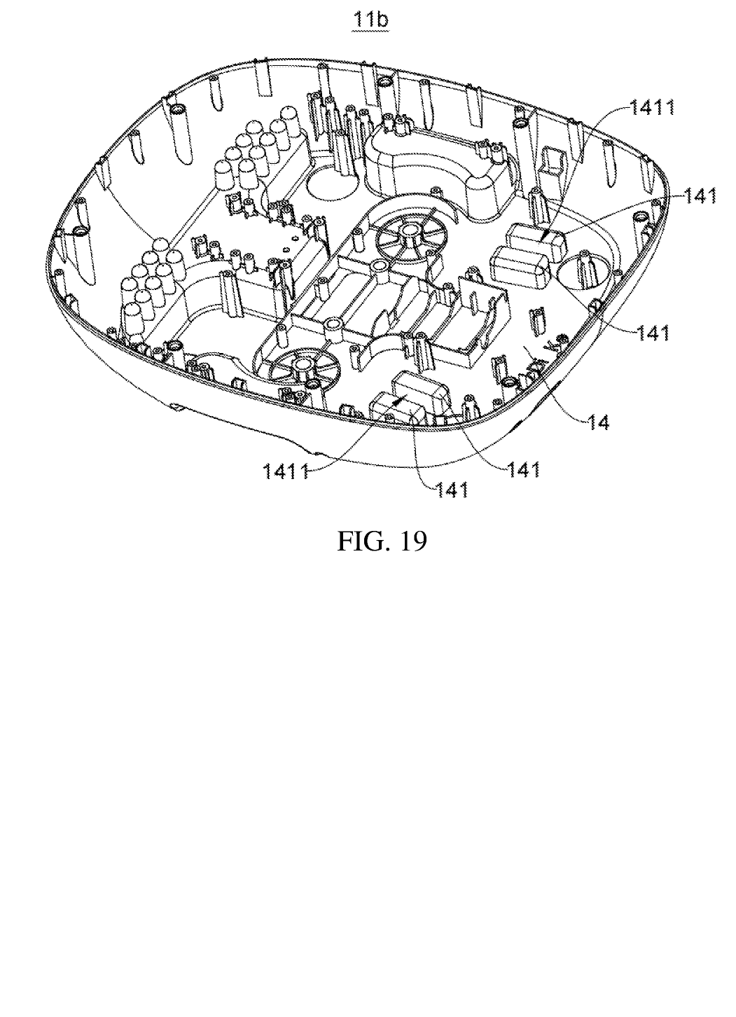

In the present embodiment, the base plate 300 is arranged within the receiving space 13, with a cavity 301 formed between the base plate 300 and the bottom 14 of the housing 11. The housing 11 may include an upper housing 11a and a lower housing 11b, the base plate 300 and the lower housing 11b together form the cavity 301. Referring to FIGS. 10 and FIG. 19, the first end 211 of the connecting rod 210 is arranged with a second limiting portion 2111. A bottom 14 of the housing 11 includes two limiting structures 141, that is, two limiting structures 141 are arranged on the bottom 14 of the lower housing 11b, and a motion space 1411 is formed between the two limiting structures 141. The second limiting portion 2111 is arranged within the motion space 1411. The two limiting structures 141 limit the movement distance of the second massage head 220 by the second limiting portion 2111. When the second massage member includes two second massage members 200, two limiting structures 141 are provided, and each set of limiting structures 141 is mated with a second massage head 220.

Referring to FIG. 18, the massage device 1 may also include an airbag massage assembly 90. The airbag massage assembly 90 can be used to apply airbag pressure to the feet and heel of the user, such that the massage effect is further improved.

In addition, it should be understood that the aforementioned embodiments are merely illustrative descriptions of the present application. Provided that the technical features do not conflict, the structures are not contradictory, and the inventive objectives of the application are not violated, the technical solutions of the various embodiments may be freely combined and used together.

Finally, it should be noted that the above embodiments are only intended to illustrate the technical solutions of the present application, and not to limit them. Although the present application has been described in detail with reference to the aforementioned embodiments, a person skilled in the art should understand that modifications can still be made to the technical solutions described in the embodiments, or some technical features can be equivalently replaced. Such modifications or replacements do not depart from the essence of the corresponding technical solutions and the spirit and scope of the technical solutions in the various embodiments of the present application.

What is claimed is:

1. A massage assembly, comprises:
a first massage member;
a second massage member;
a driving motor;
a gear assembly, the gear assembly comprising a first gear, a second gear, a third gear, a first rotating shaft, and a second rotating shaft;
wherein the first gear is connected with a working end of the driving motor, and both the first gear and the second gear are sleeved on the first rotating shaft;
wherein the third gear is engaged with the second gear, and the third gear is sleeved on the second rotating shaft, the second rotating shaft is configured to drive the first massage member and the second massage member to rotate, the number of gear teeth of the third gear is greater than that of the second gear.

2. The massage assembly according to claim 1, wherein the number of gear teeth of the first gear is greater than that of the second gear.

3. The massage assembly according to claim 1, wherein the working end of the driving motor is configured as a worm, the first gear is configured as a worm wheel, and the worm engages with the worm wheel to drive the first gear to rotate.

4. The massage assembly according to claim 1, further comprising:
a base plate forming a cavity, wherein the driving motor and the gear assembly are arranged within the cavity.

5. The massage assembly according to claim 4, wherein the first massage member comprises a tray and at least one first massage head, the tray is located on an upper side of the base plate, and the at least one first massage head is disposed on the tray, a connecting through-hole is defined in the base plate, and the second rotating shaft passes through the connecting through-hole and is connected with the tray.

6. The massage assembly according to claim 5, wherein the tray is provided with a connecting sleeve, the connecting sleeve is located at a bottom of the tray, a first limiting plane is disposed inside the connecting sleeve, the second rotating shaft is provided with a second limiting plane, the connecting sleeve is sleeved onto the second rotating shaft, and the first limiting plane is oppositely disposed to the second limiting plane.

7. The massage assembly according to claim 6, wherein the first massage member further comprises a first locking member, a first locking hole is defined in the tray, the first locking member passes through the first locking hole to be further connected to an interior of the second rotating shaft, and an inclined reinforcing rib is disposed on a peripheral side of the connecting sleeve.

8. The massage assembly according to claim 5, wherein the first massage member comprises a plurality of the first massage heads, the tray is configured as a circular or substantially circular structure, at least one of the plurality of the first massage heads is configured as a hemispherical protrusion, and the plurality of the first massage heads are distributed surrounding the tray.

9. The massage assembly according to claim 1, wherein the second massage member comprises a connecting rod and a second massage head, the connecting rod comprises a first end and a second end, the second massage head is disposed on the first end, and the second end is eccentrically connected with the third gear to drive the second massage head to reciprocate along an arcuate trajectory.

10. The massage assembly according to claim 9, wherein the third gear is provided with a cam structure, the cam structure is eccentrically arranged relative to the second rotating shaft, the cam structure rotates along with the second rotating shaft, an eccentric hole is defined at the second end of the connecting rod, and the eccentric hole is sleeved on the cam structure.

11. The massage assembly according to claim 10, wherein the cam structure comprises a cam and a fastener, the cam is disposed on the third gear and is eccentrically arranged relative to the second rotating shaft, the connecting rod is sleeved on the cam through the eccentric hole, and the fastener fixedly connects the connecting rod and the cam with each other.

12. The massage assembly according to claim 11, wherein the cam structure further comprises a second locking member, a fixing groove is defined in the cam, a fastening connection portion is arranged within the fixing groove; the fastener is provided with a second locking hole, a connecting protrusion and a first limiting portion; the first limiting portion is arranged around the connecting protrusion, the connecting protrusion is disposed within the fixing groove, the first limiting portion covers the cam and a hole wall of the eccentric hole, and the second locking member passes through the second locking hole and is fixedly connected with the fastening connection portion.

13. The massage assembly according to claim 9, wherein the connecting rod further comprises an intermediate connecting portion, the intermediate connecting portion is arranged between the first end and the second end, and the intermediate connecting portion is configured to be inclined at an angle; when the second massage head faces upward, a height of the first end is greater than a height of the second end, and the second massage head is flush or substantially flush with the first massage member.

14. The massage assembly according to claim 9, wherein the massage assembly further comprises a supporting portion, a U-shaped groove is defined in a bottom surface of the supporting portion, the second massage head is arranged within the U-shaped groove, and the U-shaped groove is configured to limit a movement distance of the second massage head.

15. The massage assembly according to claim 1, wherein the massage assembly further comprises a third massage member, the third massage member comprises a plurality of protrusion elements that are arranged in an array, and the plurality of protrusion elements are positioned to massage a target massage area of a user.

16. The massage assembly according to claim 1, wherein the massage assembly further comprises a driving module, the driving module is electrically connected to the driving motor, and the driving module is configured to control a rotating speed and a rotating direction of the driving motor.

17. A massage device, comprising:
a housing, wherein the housing is provided with an entrance and a receiving space, the entrance communicates with the receiving space; and
a massage assembly arranged within the receiving space;
wherein the massage assembly comprises a first massage member, a second massage member, a driving motor and a gear assembly;
wherein the gear assembly comprises a first gear, a second gear, a third gear, a first rotating shaft, and a second rotating shaft;
wherein the first gear is connected with a working end of the driving motor, and both the first gear and the second gear are sleeved on the first rotating shaft;
wherein the third gear is engaged with the second gear, and the third gear is sleeved on the second rotating shaft, the second rotating shaft is configured to drive the first massage member and the second massage member to rotate, the number of gear teeth of the third gear is greater than that of the second gear.

18. The massage device according to claim 17, the massage assembly comprising:
two gear assemblies, each of the two gear assemblies being the gear assembly according to claim 17;
two first massage members, each of the two first massage members being the first massage member according to claim 17; and
two second massage members, each of the two second massage members being the second massage member according to claim 17;
wherein one of the two gear assemblies is arranged on a left side of the working end of the driving motor, the other one of the two gear assemblies is arranged on a right side of the working end of the driving motor, and the driving motor is configured to simultaneously drive the two gear assemblies to rotate.

19. The massage device according to claim 18, further comprising a base plate, wherein the base plate is arranged within the receiving space, a cavity is formed between the base plate and a bottom of the housing, the cavity comprises a motor receiving portion and two gear receiving portions, the driving motor is arranged within the motor receiving portion, the two gear receiving portions are respectively positioned on the left side and the right side of the working end of the driving motor, the two gear assemblies are respectively arranged within the two gear receiving portions, each first gear of the two gear assemblies is engaged with the working end of the driving motor.
